(19) United States
(12) Patent Application Publication
(10) Pub. No.: US 2016/0353188 A1
(43) Pub. Date: Dec. 1, 2016

(54) In Loving Memory

(71) Applicant: Deborah Epps, Marietta, SC (US)

(72) Inventor: Deborah Epps, Marietta, SC (US)

(21) Appl. No.: 14/724,813

(22) Filed: May 29, 2015

(51) Int. Cl. H04R 1/02; A61G 99/00; A61G 17/08; H04N 9/87

(52) U.S. Cl. CPC H04R 1/028; H04N 9/87; A61G 99/00; A61G 17/08

(57) ABSTRACT

The present invention provides an electronic playback system for playing audio and/or video recordings of a departed person, wherein, the electronic playback system could be adapted to accommodate a funeral urn storing ashes of the departed person. The playback system comprises a memory for storing audio/video recordings; a display screen such as a LCD; a power source such as batteries; speakers; and means to connect to an external computing device or storage medium such as a USB port or a SD card reader. The playback system could be configured to mount funeral urns of different sizes and shapes.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of the Invention

The present invention generally relates to audio video playback systems. More particularly, the invention relates to an assembly that combines a funeral urn with an audio/video playback device.

(2) Background of Invention

Funeral urns, also known as cremation or cinerary urns, are vessels containing the ashes of a deceased person after cremation. The urns have been used since ancient times as a means of remembrance of the departed, as a source of meditation, and a shrine for the living. Typically, an urn is a vase shape with a narrowed neck, and is decorated. Many attempts have been made to personalize urns, including attaching pictures, or portraits of the deceased person. Moreover, the, urns are made in different sizes or shapes to enhance their ornamental value.

To cope up with the death of loved ones and remain emotionally connected, people usually collect the belongings of the departed person, particularly those close to person. People always want their loved ones to be remembered and emotionally connected. Pictures, audio, and video recordings are usually good ways to remember the departed. Recordings give the loved ones left behind a sense of continued connection through visual and sound of their departed loved ones. With recordings, they never have their loved ones fade in their minds as the time moves on. They could remember their voice and appearance.

Typically, the recordings of a person are not in one place, such as some pictures may be in a camera, others in mobile phone or in laptop, etc. Collecting all of the recordings in one place may provide convenience, but they would not be available to others. Moreover, such recordings are not easily accessible anytime, and other memorabilia could not be easily kept together with recordings. Prior art discloses devices that allow collecting the memorabilia in one place. For example, U.S. Pat. No. 7,934,299, entitled “Casket incorporating image display device,” discloses a casket that has a receptacle for human remains and digital picture frame attached to the cover of the receptacle. This displays digital photographs. The device includes memory to store digital pictures, a USB port for communication to external processing or storage device, and an LCD screen. The pictures could be viewed individually, or as a slide show.

Another, U.S. Pat. No. 7,089,495, entitled “Video enhanced grave marker,” discloses a tombstone for communicating audio and visual data related to the deceased from the tombstone. The tombstone is comprised of an indicia bearing and viewing portion, a visual display, an audio transmitter for communicating sound waves to a user, data related to the deceased, the data comprising audio and visual images of the deceased, the data stored within storage media, and means for reproducing the audio and visual images of the deceased from the data related to the deceased utilizing one or more players, readers or drivers for the one or more of the storage media.

Another, E.P. Patent 2050427, entitled “Funeral urn,” provides a receptacle for ashes that includes an electronic storage and playback device, means for triggering the playback of audio and/or visual messages stored in said storage and playback device, and a power supply. Another, U.S. Pat. No. 729,921, entitled “For preserving memorializing memorabilia,” discloses a box for the preservation of memorabilia and/or ashes of an individual. The box is comprised of containers, wherein the first container may be lockable so as to secure the contents therein. The second container is removable from the first container and has a display window that allows visual inspection of the contents therein. The marker box is interred in the ground much like a headstone, and allows visiting relatives and friends of the deceased to inspect the preserved memorabilia within the container. The container may also carry ashes of an individual. If memorabilia are to be held in the container along with the ashes, a partition may be included to seal the ashes off from the memorabilia. Alternative embodiments allow several cylinder containers to be held in one single burial marker and display box. Audio and/or video recordings may also be permanently carried by the marker box to allow visiting individuals to hear and/or see the memorialized individual or individuals.

Despite several types of devices available to collect ashes and recordings in one place, these suffer from one or more shortcomings or limitation, in particular, the use of containers for storing ashes. People usually prefer personalized urns or urns of different size and shape with different designs, or a person may want some cultural markings on the urn that are not commonly available. Devices disclosed in the prior art limits the use of urns to an inbuilt container. Thus, a need could be appreciated for a system that allows the combination urns with recordings of a deceased person. Moreover, the system should be economic to manufacture and compact for storage.

### BRIEF SUMMARY OF THE INVENTION

The present invention, therefore, has as its principal objective to provide an audio/video playback assembly for funeral urns.

Another objective of the invention is to fulfill the foregoing objective by providing a device that could store and play recordings of the deceased.

Yet another objective of the invention is that the assembly could accommodate funeral urns of different shape and sizes.

Still another objective of the current invention is that the device is compact and simple to use while also being economic to manufacture.

Certain embodiments of the current invention provide an audio/video playback assembly for funeral urns, wherein the device plays recordings of the departed person. The assembly is an electronic audio/video playback system that could accommodate funeral urns of different shapes and sizes and includes storage space for audio/video recordings, a display screen, such as LCD, a power source, such as batteries, speakers, and means to connect to an external storage or processing device, such as USB.

In another embodiment, the present invention provides an audio playback assembly for funeral urns wherein the assembly is mountable on the Urn and plays audio recordings of the departed person. It is comprised of storage, a power source, and speakers.

In addition to the various objectives and advantages of the present invention, described with some degree of specificity above, it should be obvious that additional objectives and advantages of the present invention will become more readily apparent to those persons who are skilled in the relevant art from the following more detailed description of the invention, particularly when such description is taken in conjunction with the attached drawing figures.

### BRIEF DESCRIPTION OF THE SEVERAL VIEWS OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1: shows the perspective view of the audio/video playback device that accommodates a funeral urn.

FIG. 2: shows the perspective view of the audio playback device that mounts the funeral urn.

### DETAILED DESCRIPTION OF THE INVENTION

Before explaining at least one embodiment of the invention in detail, it is to be understood that the invention is not limited in its application to the details of construction and the arrangements of the components set forth in the following description. The invention is capable of other embodiments, and of being practiced and carried out in various ways. Also, it is to be understood that the phraseology and terminology employed herein are for the purpose of description, and should not be regarded as limiting.

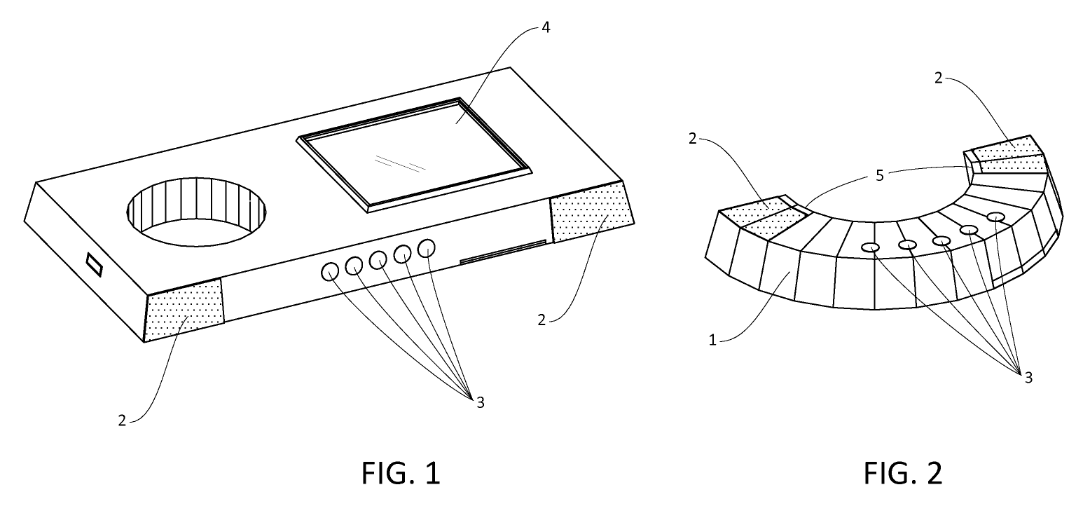

FIG. 1 illustrates that the present invention provides an audio/video assembly that plays the recordings of a deceased person. The recordings include the pictures, sounds, and videos of the person during his lifetime. The figure shows a base 1 that could accommodate the funeral urn. Commercial urns come in many shapes or sizes and colors. The base 1 can accommodate urns of different size or shape, and the assembly itself could be easily customized to accommodate an urn of a particular size or shape. The assembly contains speakers 2 to play the sound without the need of any external audio speakers or headphones. The assembly contains at least one speaker, and, preferably, one or two speakers are used to make the assembly compact and economical. In FIG. 1, two speakers are incorporated on the left and right side of the device that is coupled to each of two channels of the audio signal. Many kinds of speakers are available commercially, and each differs in sound output. The types of speakers and the technology behind the speakers are obvious to a skilled person. Thus, the assembly may include speakers depending on the user requirements, cost, and design feasibility.

Furthermore, FIG. 1 shows the control buttons 3 that could be used to operate the audio/video system. The buttons include means to play, pause, or stop the track being played. The incorporation of such controls is not limited to the present description, and may include controls to create a playlist, move forward or backward, or skip a track. The playlist or list of available recordings may be viewed on the display screen 4. Optionally, the assembly further includes a device to operate the audio/video system remotely. The assembly may include a touch interface. An LCD display 4 displays the pictures, slideshows, or video recordings played by the audio/video device. Instead of LCD, any other kind of display screen that is known to a skilled person may be incorporated, including rigid or flexible screens. Optionally, the panel may have a cover to protect the display screen and the frame. This cover incorporates the display screen, which may be hidden in the assembly and comes out for viewing. Furthermore, the display screen could be adjusted to a particular viewing angle by rotating the screen.

The assembly includes internal storage space to store the recordings. External storage, such as memory cards or pen drives, could also be used. The assembly includes means to connect the device to an external processing system, such as a computer or storage device, for adding or removing the recordings to the storage. Such means include USB ports, Bluetooth, or Wi-Fi systems.

The assembly could be powered using batteries, which may optionally be rechargeable or charged by solar energy or AC current. Combinations of two or more power sources could be provided, such as solar energy and AC current, whereby the AC current provide backup in case solar energy is net feasible. In case AC current is used, the assembly includes appropriate AC to DC converters. The system includes drivers to play audio or video tracks or pictures. Optionally, the system allows playing slideshows of the pictures. The system could be paused and resumed anytime, at any track or picture.

In another embodiment, as illustrated in FIG. 2, the assembly includes the audio system, but no video. The assembly could play audio recordings, and is of curved shape that accommodates a funeral urn in the inner arc 1. The device could be customized to a particular funeral urn.

Those skilled in the art should appreciate that they can readily use the disclosed conception and specific embodiment as a basis for designing or modifying other structures for carrying out the same purposes of the present invention, and that such other structures do not depart from the spirit and scope of the invention in its broadest form.

I claim:

1. An audio/video playback assembly for a funeral urn comprising;
a. a base to accommodate said urn;
b. audio means to transmit audio signals;
c. display means to display pictures and video signals;
d. means to connect said assembly to an external processing unit or a storage;
e. means for reading data from a non-transitory memory; and
f. a power source.

2. The assembly of claim 1, wherein said urn having different shapes and sizes.

3. The assembly of claim 1, wherein said audio means is a speaker.

4. The assembly of claim 1, wherein said display means is an LCD screen.

5. The assembly of claim 1, wherein said means to connect said assembly to a storage is a USB port.

6. The assembly of claim 1, wherein said means to connect said assembly to an external processing unit or a storage is a Bluetooth.

7. The assembly of claim 1, wherein said means for reading non-transitory memory is an internal non-transitory memory.

8. The assembly of claim 1, wherein said means for reading non-transitory memory is an external memory stick or memory card.

9. An audio playback assembly for funeral urn comprising:
a. a base for accommodation of said urn;
b. audio means for transmitting audio signals;
c. means for connecting said assembly to an external processing unit or a storage;
d. means for reading data from a non-transitory memory; and
e. a power source.

10. The assembly of claim 9, wherein said urn could be of different shape and sizes.

11. The assembly of claim 9, wherein said audio means is a speaker.

12. The assembly of claim 9, wherein said means for connecting said assembly to an external processing unit or a storage is a USB port.

13. The assembly of claim 9, wherein said means for connect said assembly to an external processing unit or a storage is a Bluetooth.

14. The assembly of claim 9, wherein said non-transitory memory is an internal non-transitory memory.

15. The assembly of claim 9, wherein said non-transitory memory is an external memory stick or memory card.
